(19) United States
(12) Patent Application Publication
(10) Pub. No.: US 2025/0076680 A1
(43) Pub. Date: Mar. 6, 2025

(54) FLEXIBLE EYEWEAR WITH FLEXIBLE PAINT

(71) Applicant: BRENT SHELDON, MIAMI, FL (US)

(72) Inventors: BRENT SHELDON, MIAMI, FL (US); GUY BROUSSEAU, JR., MARIEVILLE (CA)

(21) Appl. No.: 18/950,245

(22) Filed: Nov. 18, 2024

Related U.S. Application Data
(63) Continuation of application No. PCT/CA2023/050685, filed on May 17, 2023.
(60) Provisional application No. 63/343,170, filed on May 18, 2022.

(51) Int. Cl. G02C 5/06

(52) U.S. Cl. CPC G02C 5/06

(57) ABSTRACT

An eyewear is provided. The eyewear includes at least one rigid portion, at least one flexible portion and a layer of flexible paint applied over and across each of the at least one rigid portion and the at least one flexible portion. The at least one rigid material is made of a first material, the at least one flexible portion is made of a second material, and the flexible paint is made of a third material that is adapted to bond with each of the first and the second materials

### CROSS REFERENCE TO PRIOR APPLICATIONS

The present application is a Continuation of PCT Application No. PCT/CA2023/050685 filed on May 17, 2023, which claims priority from U.S. Provisional Patent Application No. 63/343,170, filed on May 18, 2022, the contents of which are incorporated herein by reference as if set forth in their entirety.

### TECHNICAL FIELD

The present disclosure generally relates to flexible eyewear and particularly to flexible eyewear utilizing a flexible paint to apply coloring to the eyewear.

### BACKGROUND

Products that are assembled from multiple pieces and are meant to have a uniform color, at least across multiple pieces, require careful matching of colors in those pieces. However, some individual pieces or parts in the assembly may be made from different materials, which are difficult to match. For example, a multi-component product such as eyewear may have a flexible portion made from a flexible material and rigid component(s) made from a rigid material. These flexible and rigid materials typically have different surface finishes. Moreover, it can be difficult to match the color in these different materials.

### SUMMARY

In one aspect, an eyewear is provided. The eyewear includes at least one rigid portion, at least one flexible portion and a layer of flexible paint applied over and across each of the at least one rigid portion and the at least one flexible portion. The at least one rigid material is made of a first material, the at least one flexible portion is made of a second material, and the flexible paint is made of a third material that is adapted to bond with each of the first and the second materials.

In another aspect, a flexible eyewear assembly is provided. The flexible eyewear assembly includes a first and a second lens retainer for retaining a respective lens therein. The first and the second lens retainers are made of a rigid material. The flexible eyewear assembly includes a bridge portion connecting the first and the second lens retainers. The bridge portion is made of a flexible material and is adapted to permit flexure of the first and second lens retainers relative to each other. The flexible eyewear assembly further includes a layer of flexible pain material applied and bonded across each of the rigid material of the first and second lens retainers and the flexible material of the bridge portion.

In a yet another aspect, a flexible eyewear assembly is provided. The assembly includes a first and second rigid lens retainers for retaining respective lenses therein. Each of the first and second rigid lens retainers are made of a first material and are coated with a layer of second material. The assembly further includes a flexible bridge portion connecting the first and second rigid lens retainers. The flexible bridge portion is made of the second material and is adapted to permit flexure of the rigid first and second lens retainers relative to each other in at least one direction. The assembly further includes a layer of flexible paint applied over and bonded across the flexible bridge portion and each of the first and second rigid lens retainers coated with the second material.

In a yet another aspect, a method of making a flexible eyewear assembly for retaining a pair of lenses therein, is provided. The method includes providing a first and second lens retainer. The first and the second lens retainers are made of a first material and are adapted to retain a respective first and second lens therein. The method includes connecting the first and second lens retainers by a bridge portion, the bridge portion being made of a second material that is different from the first material. The method further includes applying a layer of flexible paint over and across each of the first and second lens retainers and the bridge portion. The flexible paint is made of a third material that can bond with the first and second materials.

### BRIEF DESCRIPTION OF THE DRAWINGS

Embodiments will now be described with reference to the appended drawings wherein:

FIG. 1 is an image of a portion of prior art flexible eyewear illustrating a peeling and cracked coating on the flexible portion.

FIG. 2 is an image of a portion of another prior art flexible eyewear illustrating a peeling and cracked coating on the flexible portion.

FIG. 3a illustrates a flexible eyewear with differently colored parts.

FIG. 3b illustrates the flexible eyewear of FIG. 3a with a flexible paint applied to a portion of the eyewear spanning the differently colored parts, including a flexible portion.

FIG. 4a is a schematic view of a flexible multi-component product with a flexible portion coupled to a pair of rigid portions.

FIG. 4b is a schematic view of the product of FIG. 4a with a flexible paint applied across both the flexible and rigid portions.

FIG. 4c is a schematic diagram of a portion of FIG. 4b illustrating flexing of the flexible portion with both stretching and compression forces acting on opposite areas of the applied flexible paint.

FIG. 5a illustrates the flexible eyewear of FIG. 3b flexed in one direction.

FIG. 5b illustrates an enlarged view of the flexible portion of the eyewear of FIG. 5a.

FIG. 6a illustrates the flexible eyewear of FIG. 3b flexed in the opposite direction to that shown in FIG. 5a.

FIG. 6b illustrates an enlarged view of the flexible portion of the eyewear of FIG. 6a.

FIGS. 7a to 7c illustrate schematic views of the flexible eyewear with a flexible paint applied thereon according to another example.

### DETAILED DESCRIPTION

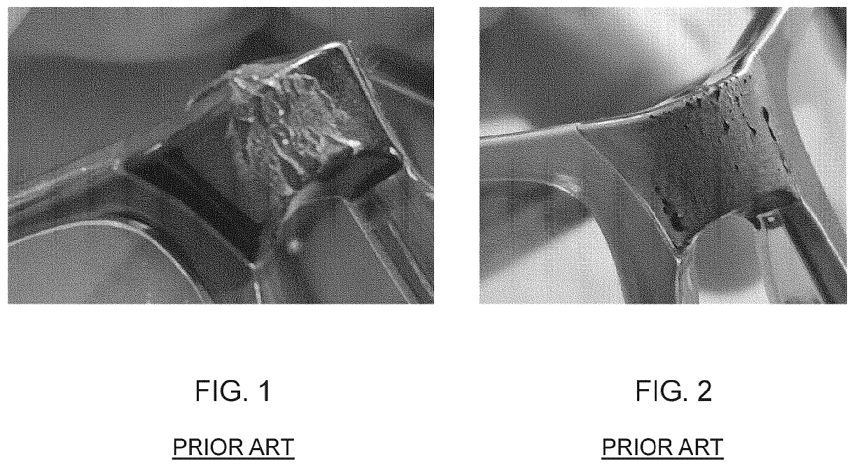

Instead of attempting to match colors of individual parts in a multi-component product, attempts have been made to apply a paint or other coating to the product. However, it is found that when such products can flex significantly in particular places, as is the case in eyewear with flexible parts, the paint or other coating tends to crack and/or peel, particularly when applied to a material that flexes, and after repeated bending and reforming operations. Such peeling is observed in prior art eyewear with a coating shown in FIGS. 1 and 2.

To address the peeling and other deterioration of a coating, such as paint, on a flexible portion of an eyewear, the following describes a flexible eyewear which has a layer of flexible paint, capable of bonding to the other materials being used in the eyewear, applied and bonded to at least the flexible portion of the eyewear. As will be described below, the flexible paint can also be applied and bonded to multiple parts, even being constructed from different materials, to provide a continuous surface such that the multiple underlying parts appear to be uniform and continuous. In this way, the eyewear that allows for significant flexibility at certain points or in certain parts, can maintain a smooth painted finish during such significant flexure, without the cracking and peeling that would otherwise occur without a flexible paint product that has the correct adhesion and bonding properties to the surfaces of the particular materials being used.

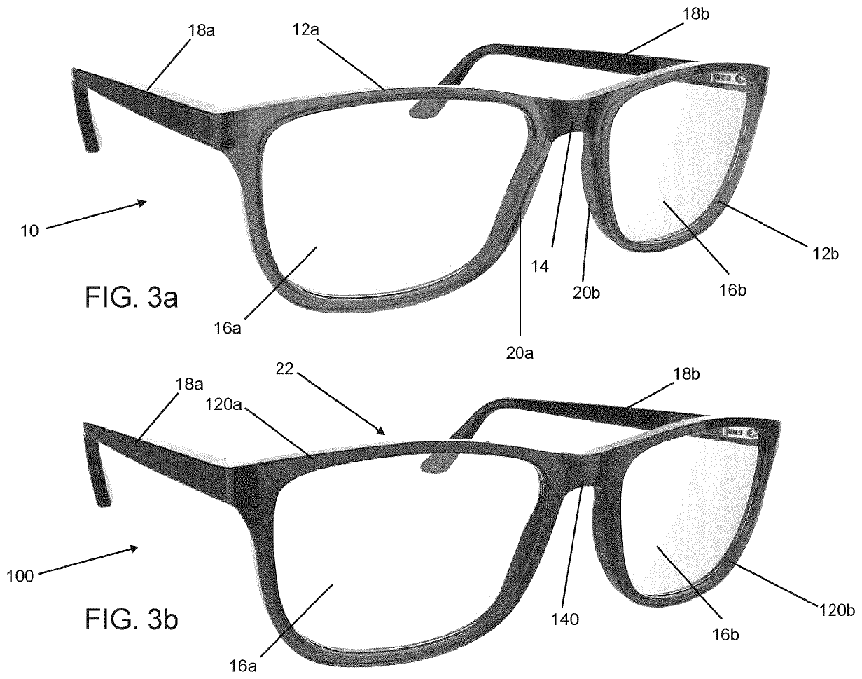

To this end, FIG. 3a illustrates a perspective view of an example assembled eyewear 10, also referred to interchangeably herein as an eyewear assembly 10 or eyewear 10 for brevity. The eyewear 10 includes a pair of separate lens retainers 12, in this example a first lens retainer 12a and a second lens retainer 12b. The lens retainers 12a, 12b are adapted to hold lenses therein and may, in some examples, be rigid to provide stability and support for the lenses and maintain the shape of the eyeglasses such that they consistently fit on a user's face, as desired. In one example, a first lens 16a is held by the first lens retainer 12a and a second lens 16b is held by the second lens retainer 12b. A first arm 18a is connected to the first lens retainer 12a, and a second arm 18b is connected to the second lens retainer 12b. The first lens retainer 12a includes or otherwise supports a first nose piece 20a, and the second lens retainer 12b includes or otherwise supports a second nose piece 20b. The nose pieces 20 may also be referred to as, or considered to be, nose engaging portions or nose pads. Moreover, the nose pieces 20 shown in FIG. 3a are for illustrative purposes only.

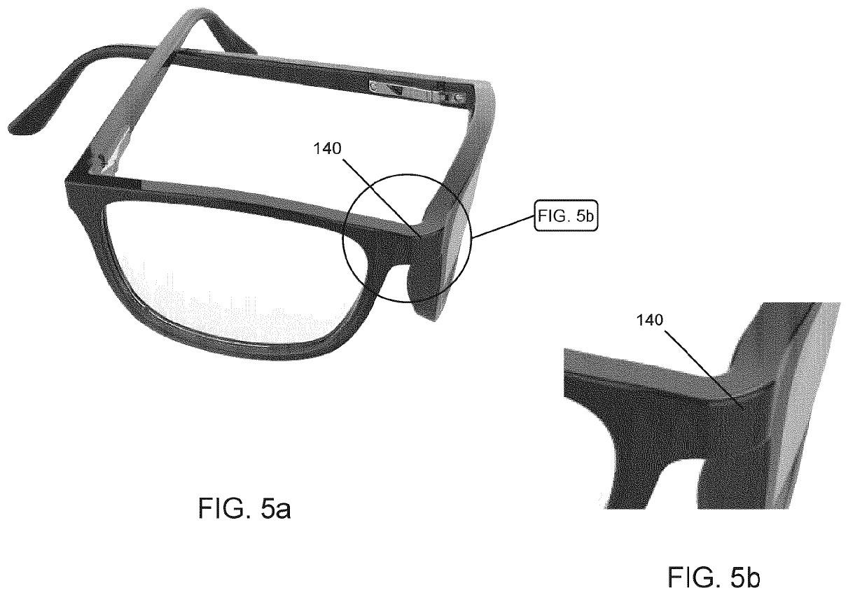

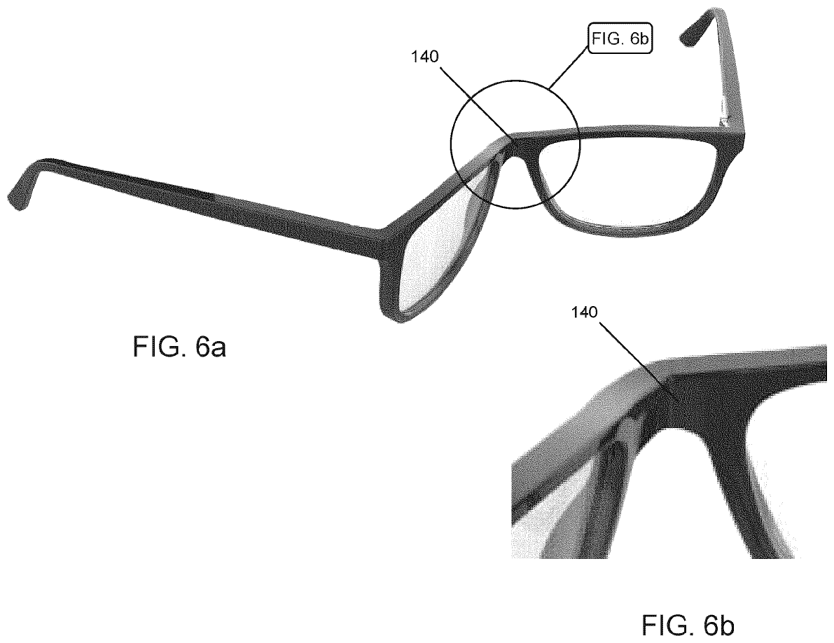

The lens retainers 12a and 12b are connected to each other via a bridge portion 14. In an example embodiment, the bridge portion 14 may be a flexible bridge portion, also referred to interchangeably herein as the flexible portion 14 or bridge portion 14. The lens retainers 12a and 12a are connected to the bridge portion 14 such that they are positioned on either side of the user's head and aligned with their eyes. The flexible bridge portion 14 enables the eyewear 10 to be flexed such that the lens retainers 12a, 12b and arms 18a, 18b attached thereto can be bent or otherwise separated or twisted relative to each other (see also FIGS. 5 and 6 described below). This allows, for example, a user to slightly flex the arms 18a, 18b away from each other when placing the eyewear 10 on their head, with resiliency in the flexible bridge portion 14 causing the arms 18a, 18b to return towards each other and seat against the user's head and on their ears. As described further below, more significant flexibility may also be permitted. The flexibility also resists breakage of the lens retainers 12a, 12b by permitting them to flex, twist, and to a certain extent, fold, e.g., if the eyewear 10 falls, is sat upon by the user, is stuffed into a purse or bag, etc. Such flexing often occurs on a regular basis, even with every use and in this respect is considered relatively more flexibility than the inherent flexibility of an otherwise rigid eyewear frame.

In some implementations, the lens retainers 12a, 12b may be made from a rigid first material, such as plastic, metal, acetate, composite materials or another suitable rigid materials. Further, the flexible bridge portion 14 may be constructed from a flexible second material, such as an elastomer such as thermoplastic polyurethane (TPU), rubber or thermoplastic rubber (TRP), soft plastic, or any other suitable material. The flexible bridge portion 14 and the lens retainers 12a, 12b can be joined to each other in any suitable manner, for example as described in U.S. Pat. Nos. 9,527,252 and 11,126,009, the contents of which are incorporated herein by reference.

As can be seen in FIG. 3a, the lens retainers 12a, 12b are differently colored than the flexible portion 14 and the arms 18a, 18b. Rather than trying to match pigments in the material used to construct the lens retainers 12a, 12b with the color and finish of the flexible portion 14 and/or arms 18a, 18b, a flexible paint 22 can be applied to at least a portion of the surfaces of the lens retainers 12a, 12b and flexible portion 14. FIG. 3b illustrates the effect of applying such a pain. As indicated above, since the flexible portion 14 permits a high degree of flexure in the area of the flexible portion 14, most paints and other coatings would suffer from cracking or peeling after repeated flexing, as shown in FIGS. 1 and 2 and/or due to being used in various different environments such as sunlight, varying temperatures, wind and rain, different humidity, etc. Thus, the flexible paint 22 provides a protective layer, while also providing smooth aesthetics for the eyewear 10, to prevent such cracking or peeling when the flexible portion 14 is flexed.

In one embodiment, the flexible paint 22 is made of a third material that is capable of bonding with the first material, i.e., the material of the lens retainers 12, and the second material, i.e., the material of the bridge portion. In some example implementations, the flexible paint 22 may be made of an elastomeric material, acrylic polymer based material, an epoxy resin based material, a silicone based coating material or a plasticized coating material. In some other examples, radiation (e.g., Ultraviolet (UV)) curable coatings based on polyether, polyester, or urethane acrylates may also be used for making the flexible paint 22. In some yet other examples, the flexible paint 22 may be made of a composite material that can bond with the first and second materials of the eyewear 10.

Referring now to FIG. 3b, applying the flexible paint 22 results in painted eyewear 100. In this example, the flexible paint 22 is applied over an upper portion of the lens retainers 120a, 120b to retain some of the color of the original material to provide a multi-color effect. A painted flexible portion 140 also results with a smooth transition between the lens retainers 120a, 120b and the painted flexible portion 140 providing a uniform finish to the painted eyewear 100.

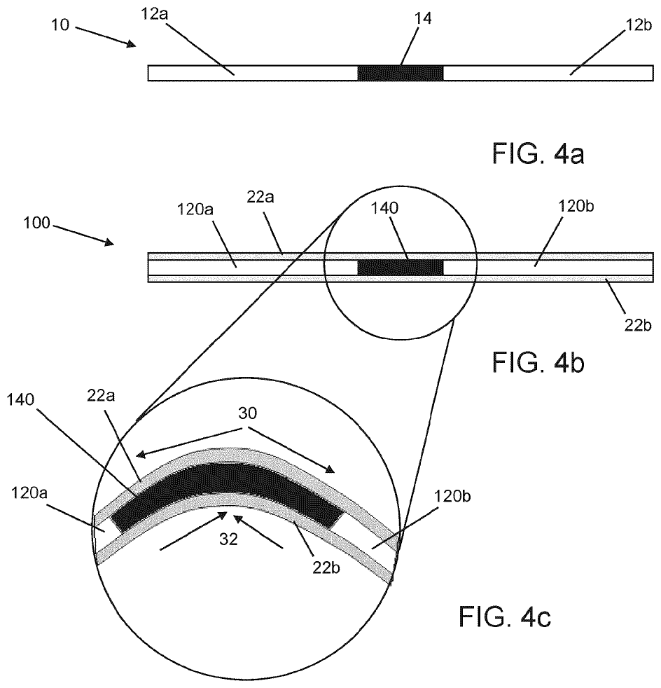

FIG. 4a illustrates a schematic view of eyewear 10 having lens retainers 12a, 12b interconnected via the flexible bridge portion 14. This schematic view also provides a cross-sectional plan view as shown in FIG. 4b. In this view, the flexible paint 22 is shown as a front layer 22a and a rear layer 22b by virtue of the cross-section. As illustrated in FIG. 4b, the flexible paint layers 22a, and 22b provide continuous outer surfaces spanning across both the lens retainers 120a, 120b and the painted flexible bridge portion 140. By using a flexible paint 22, flexure of the eyewear 100 as shown in FIG. 4c can be accommodated while inhibiting breakage, peeling, cracking, and separation. In this example, the front layer 22a stretches (shown by arrows 30) as the underlying flexible bridge portion 140 bends outwardly while the rear layer 22b compresses (shown by arrows 32). That is, there are typically multiple different forces and effects imparted on the surface created by the flexible paint 22. The resilient properties of the flexible paint 22 allows the flexure to occur and the eyewear 100 to return to the state shown in FIG. 4b while the paint simultaneously returns to its rest state without cracking, peeling or separating from the underlying layer. The flexible paint 22 should therefore have properties enabling it to adhere/bind to both materials, namely such that it can bond to both the material used by the flexible bridge portion 14 (e.g., a flexible rubber) and the material used by the rigid lens retainers 12a, 12b (e.g., a rigid acetate, metal, plastic, etc.).

FIGS. 5a and 5b illustrate a significant flexure of the eyewear 100 shown in FIG. 3b in one direction with FIG. 5b providing an enlarged view of the painted flexible bridge portion 140 illustrating its ability to withstand the flexing due to the elastic properties of the paint 22. Similarly, FIGS. 6a and 6b show another significant flexure of the eyewear 100 in the opposite direction. Again, the flexible portion 140 can withstand both compression and stretching of the outer layers 22a, 22b depending on the flexure imparted. It can be appreciated that these principles apply to other types of flexure such as twisting or flexing about other axes. The flexible paint can be prepared for application by choosing a paint color, elastomer, and any additive(s) that provides suitable bonding or adhesive properties for the underlying materials. That is, depending on the material(s) used, the additive can be chosen and, if necessary, tested to determine suitable adhesion and bonding while providing the inherent flexibility of the elastomer.

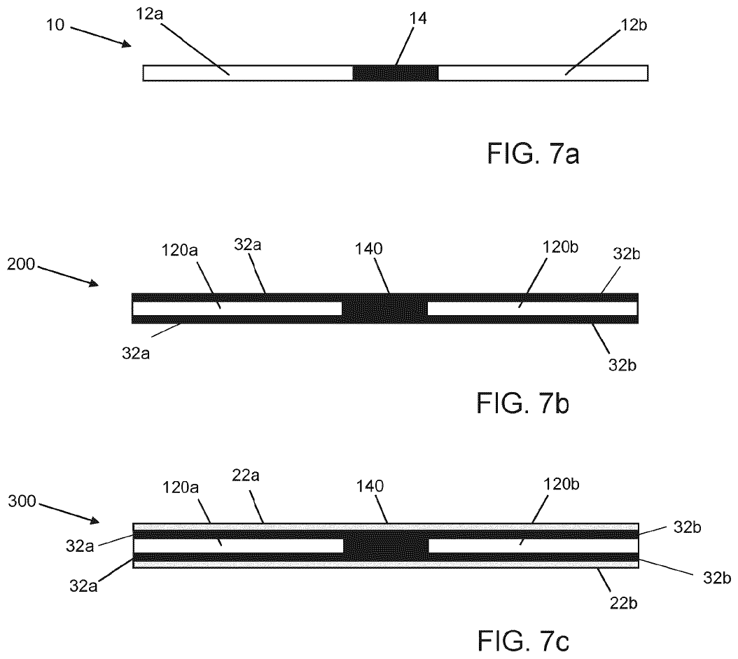

In another example embodiment, such as the one shown in FIGS. 7a to 7C, only a single material to which the flexible paint bonds may be used. For example, the rigid lens retainers 12 may first be coated with a layer of the second material 32, e.g., the material with which the flexible bridge 14 is made (to obtain the intermediate eyewear 200), and the flexible paint 22 may be applied over and to bond with the second material 32 only (to obtain the final eyewear 300). Coating the lens retainers 12 with the same material as that of the bridge portion 14 provides a smooth single surface across the eyewear for the flexible paint 22 to bond with. As such, the principles discussed herein can equally apply to any one or more materials, at least a portion of which provides the significant flexibility discussed herein.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures, and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams or otherwise described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. An eyewear comprising:
at least one rigid portion made of a first material;
at least one flexible portion made of a second material; and
a layer of flexible paint applied over and across each of the at least one rigid portion and the at least one flexible portion, the flexible paint being made of a third material and is adapted to bond with each of the first and the second materials.

2. The eyewear of claim 1, wherein the first material includes one or more of rigid plastic, metal, acetate, or composite material.

3. The eyewear of claim 1, wherein the second material includes one or more of soft plastic, rubber, thermoplastic rubber (TRP), thermoplastic polyurethane (TPU) or elastomer.

4. The eyewear of claim 1, wherein the third material includes an elastomer based material.

5. The eyewear of claim 1, wherein the third material includes acrylic polymers.

6. The eyewear of claim 1, wherein the third material includes an epoxy resin or silicone based paint material.

7. The eyewear of claim 1, wherein the third material includes a plasticized paint material.

8. A flexible eyewear assembly comprising:
first and second lens retainers for retaining respective lens therein, the first and second lens retainers being made of a rigid material;
a bridge portion connecting the first and the second lens retainers, the bridge portion being made of a flexible material to permit flexure of the first and second lens retainers relative to each another in at least one direction; and
a layer of flexible paint material applied and bonded across each of the rigid material of the first and second lens retainers and the flexible material of the bridge portion.

9. A flexible eyewear assembly comprising:
first and second rigid lens retainers for retaining respective lens therein, each of the first and second rigid lens retainers being made of a first material and coated with a layer of second material;
a flexible bridge portion connecting the first and second rigid lens retainers, the flexible bridge portion being made of the second material to permit flexure of the first and second lens retainers relative to each another in at least one direction; and
a layer of flexible paint applied over and bonded across the flexible bridge portion and each of the first and second rigid lens retainers coated with the second material.

10. The flexible eyewear assembly of claim 9, wherein the first material includes one or more of rigid plastic, metal, acetate, or composite material.

11. The flexible eyewear assembly of claim 9, wherein the second material includes one or more of soft plastic, rubber, thermoplastic rubber (TRP), thermoplastic polyurethane (TPU) or elastomer.

12. The flexible eyewear assembly of claim 9, wherein the flexible paint is made of an elastomer based material.

13. The flexible eyewear assembly of claim 9, wherein the flexible paint is made of acrylic polymers based material.

14. The flexible eyewear assembly of claim 9, wherein the flexible paint is made of an epoxy resin or silicone based material.

15. The flexible eyewear assembly of claim 9, wherein the flexible paint is made of a plasticized coating material.

16. A method of making a flexible eyewear assembly for retaining a pair of lenses therein, the method comprising:
providing a first lens retainer made of a first material, the first lens retainer being adapted to retain a first lens therein;
providing a second lens retainer made of the first material, the second lens retainer being adapted to retain a second lens therein;
connecting the first and second lens retainers by a bridge portion, the bridge portion being made of a second material different from the first material;
applying a layer of flexible paint over and across each of the first and second lens retainers and the bridge portion, the flexible paint being made of a third material adapted to bond with each of the first and the second materials.

17. The method of claim 16, wherein the first material includes one or more of rigid plastic, metal, acetate, or composite material.

18. The method of claim 16, wherein the second material includes one or more of soft plastic, rubber, thermoplastic rubber (TRP), thermoplastic polyurethane (TPU) or elastomer.

19. The method of claim 16, wherein the third material includes one or more of an elastomer based material, acrylic polymers based material, epoxy resin based material, silicone based material, and a plasticized coating material.

20. The method of claim 16 further comprising coating each of the first and second lens retainers with a layer of second material prior to applying the layer of flexible paint thereon.
